(19) United States
(12) Patent Application Publication
(10) Pub. No.: US 2007/0058332 A1
(43) Pub. Date: Mar. 15, 2007

(54) POWERED DOCKING USB HUBS FOR A WAGERING GAME MACHINE

(76) Inventors: Stephen A. Canterbury, Antioch, IL (US); Victor Mercado, Berwyn, IL (US); Mark V. Page, East Chicago, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/421,631

(22) Filed: Jun. 1, 2006

Related U.S. Application Data
(60) Provisional application No. 60/686,591, filed on Jun. 2, 2005.

(51) Int. Cl. G06F 1/16

(52) U.S. Cl. 361/683

(57) ABSTRACT

Methods and apparatus for docking and powering Universal Serial Bus hubs in a wagering game machine are described herein. In one embodiment, a docking Universal Serial Bus (USB) power unit includes a USB socket to receive USB data and a power socket to receive power of a first type. The USB power unit can also include a switching power unit to convert the power of the first type into power of a second type. The power unit can also include a docking connector to join the docking USB power unit to a USB hub, where the USB hub is to dock with the docking USB power unit, and where the docking connector to conduct the USB data and some of the power of the second type to the USB hub.

### RELATED APPLICATION

This application claims priority under 35 U.S.C. 119(e) from U.S. Provisional Application Ser. No. 60/686,591 filed Jun. 2, 2005, which application is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### FIELD

This invention relates generally to the field of connecting peripheral devices to wagering game machines and more particularly to connecting Universal Serial Bus components.

### BACKGROUND

Peripheral devices often provide important services for computer systems. In order to encourage peripheral device development, computer system designers devised the Universal Serial Bus standard, which defines a communication and power interface for computers and peripheral devices. While USB connectivity is ubiquitous in desktop computing, it is only beginning to catch-on in wagering game systems (e.g., video slot machines).

Many computer systems include a native USB controller and one, two, or three USB ports for connecting with USB peripheral devices. Computer systems needing more than two or three USB peripheral devices often employ one or more USB hubs, which provide several additional USB ports. USB hubs often include power supplies, controllers, and other components. As computer systems need more USB connectivity, the need for USB hubs increases. Using several USB hubs in a single system can be expensive because components are often duplicated (e.g., power supplies). Additionally, USB hubs containing duplicate components may occupy considerable space. Thus, USB hubs may be impractical for systems having space constraints (e.g., cabinet style wagering game systems).

### BRIEF DESCRIPTION OF THE FIGURES

The present invention is illustrated by way of example and not limitation in the Figures of the accompanying drawings in which:

FIG. 1 is a frontal view of a docking USB power unit and docking USB hubs, according to example embodiments of the invention;

FIG. 2 is a rear view of a docking USB power unit and docking USB hubs, according to example embodiments of the invention;

FIG. 3 is a block diagram illustrating a docking USB power unit and hub, according to example embodiments of the invention;

FIG. 4 is a block diagram illustrating a gaming machine, used in conjunction with exemplary embodiments of the invention;

FIG. 5 is a perspective view of a gaming machine, according to example embodiments of the invention;

FIG. 6 is a flow diagram illustrating operations for determining power consumption of USB devices, according to example embodiments of the invention;

FIG. 7 is a flow diagram illustrating operations for creating a power consumption report, according to example embodiments of the invention; and

FIG. 8 shows human-readable gaming machine reports, according to example embodiments of the invention.

### DESCRIPTION OF THE EMBODIMENTS

Systems and methods for powering and docking Universal Serial Bus (USB) hubs are described herein. This description of the embodiments is divided into five sections. The first section describes example hardware and an example operating environment. The second section describes example operations and the third section describes example power information reports. The fourth section provides some general comments.

### Example Hardware and Operating Environment

This section describes an example system for docking and powering USB hubs. This section also describes an example computer system in which embodiments can be practiced. Operations of the system will be described in the next section.

### Example System

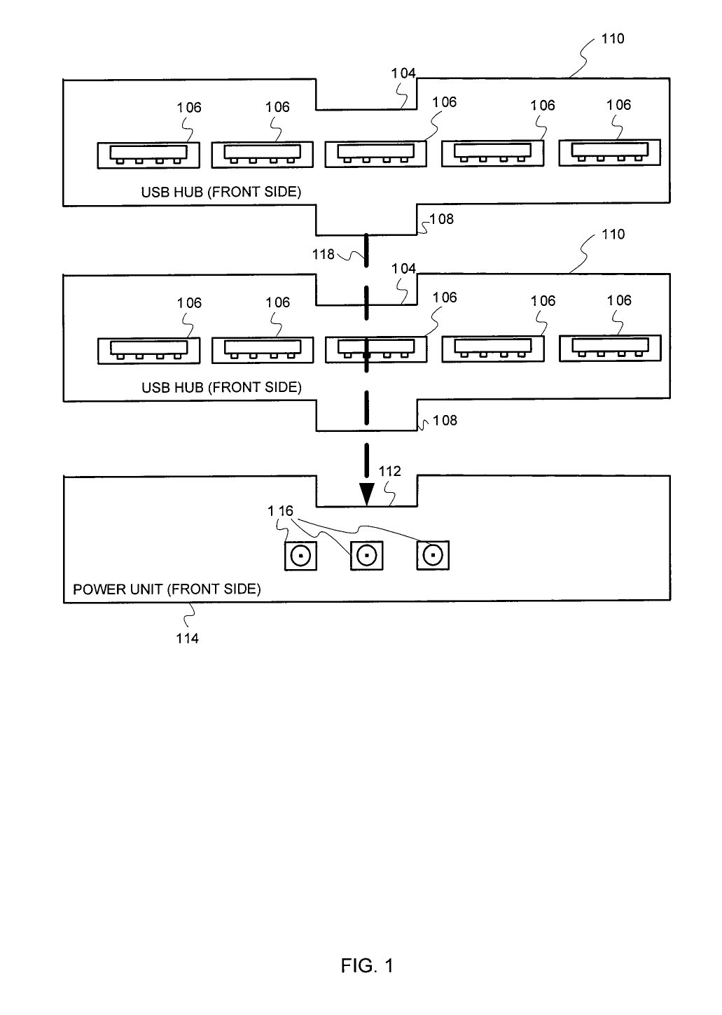

FIG. 1 is a frontal view of a docking USB power unit and docking USB hubs, according to example embodiments of the invention. FIG. 1 shows a front-side view of a docking USB power unit 114 and docking USB hubs 110. The power unit 114 includes three power output jacks 116 and a docking socket 112. Each power output jack 116 can supply power to a device that would not require USB communication. For example, the power output jack 116 can supply power to a lamp assembly in a wagering game machine. The docking socket 112 can physically couple the power unit 114 to a USB hub 110, forming a stack (e.g., the power unit 114 and USB hubs 110 can be docked in a formation centered on the axis 118). Additionally, the docking socket 112 can conduct power from the power unit 114 to USB hubs 110.

Each USB hub 110 can include a plurality of USB sockets 106 and a docking connector 108 and docking socket 104. In one embodiment, the USB sockets 106 can be made of a single connector, such as Framatone Connectors International's part number 55917-xxx that provides for standard USB signals and additional power. Alternatively, the USB sockets 106 can include two connectors: one connector for standard USB signals which could receive Type A USB connectors, Type B USB connectors, or any other suitable USB connector and another connector for the additional power. The USB hub's docking connector 108 can mate with a power unit's docking socket 112, forming a stack. The USB hub's docking socket 104 can mate with another USB hub's docking connector 108. As a result, a plurality of USB hubs 110 can be stacked with a USB power unit 114. According to embodiments, each USB hub's docking connector 108 and docking socket 104 can conduct power and USB data to other USB hubs in the stack.

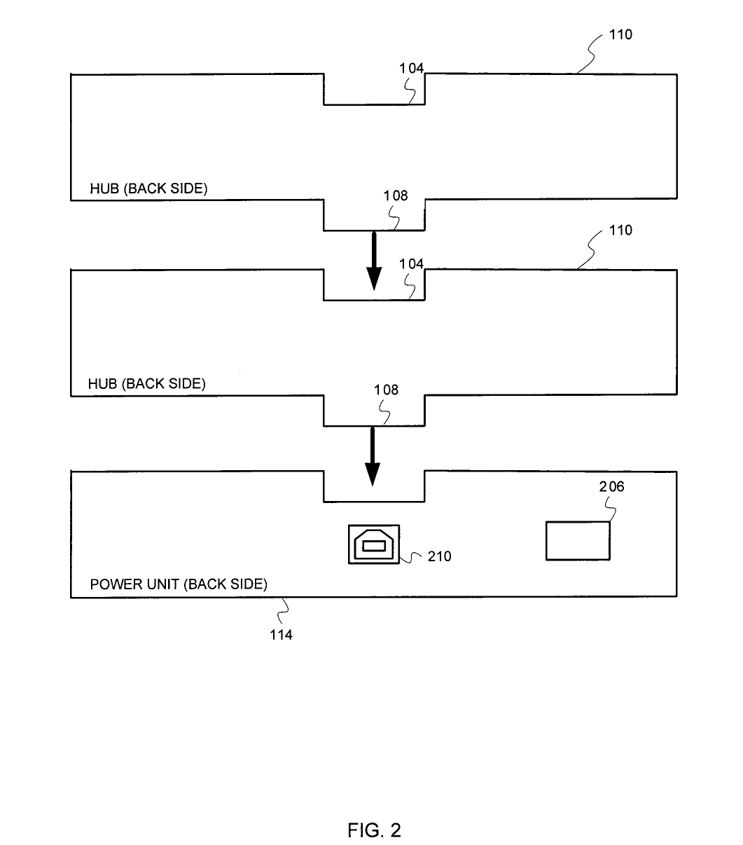

FIG. 2 is a rear view of a docking USB power unit and docking USB hubs, according to example embodiments of the invention. FIG. 2 shows the docking power unit 114 and docking USB hubs 110. The power unit 114 includes a USB socket 210 and power input 206. The USB socket 210 can be adapted to receive a Type B USB connector, Type A USB connector, or any other suitable USB connector. The power input 206 can receive power from an AC or DC power source.

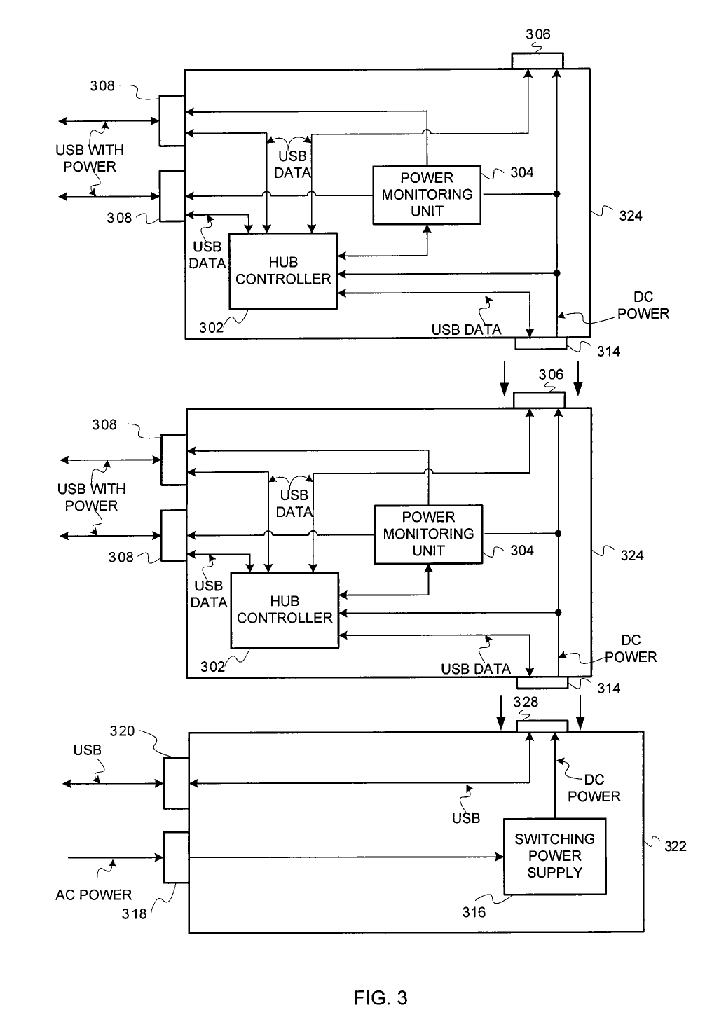

While FIGS. 1 and 2 provide views of a docking USB power unit and docking USB hubs, FIG. 3 provides a schematic of these components.

FIG. 3 is a block diagram illustrating a docking USB power unit and hub, according to example embodiments of the invention. As shown in FIG. 3, a docking USB power unit 322 includes a power input 318, which is connected to switching power supply 316. The switching power supply 316 is connected to a docking socket 328. The docking socket 328 is also connected to a USB port 320, which can be used for establishing an upstream connection to a host processor (not shown). In one embodiment, the USB connector 320 conducts USB data to the docking socket 328, which in turn conducts the USB data to another docking USB hub 324. The USB port 320 can also conduct USB power (e.g., 5V@100 mA) to the docking socket 328.

In one embodiment, the switching power supply 316 receives AC power (e.g., 115V), while in another embodiment, it receives DC power (e.g., 48V). In one embodiment, the switching power supply 316 converts power into +5V, +12V, and +24V. However, the switching power supply 316 can convert power into other suitable voltages. In one embodiment the switching power supply 316 provides +5V, +12V, and +24V voltage rails to the USB hub 324, so each of the USB hub's USB sockets 308 can deliver +5V, +12V, and +24V. In another embodiment, the switching power supply 316 provides +48 volts to the USB hubs 324, which processes the power in order to provide USB sockets that can deliver +5V, +12V, and +24V.

The docking USB hub 324 includes a docking connector 314, USB hub controller 302, power monitoring unit 304, docking socket 306, and USB sockets 308. The docking connector 314 can conduct power to the hub controller 302, USB sockets 308, power monitoring unit 304, and docking socket 306. The docking connector 314 also conducts USB data to the hub controller 302.

The hub controller 302 is connected to the docking connector 314, USB sockets 308, docking socket 306, and power monitoring unit 304. The hub controller 302 can conduct USB data to the USB sockets 308 and docking socket 306. In one embodiment, the hub controller 302 can process USB data and power requests in a manner consistent with a USB specification (e.g., USB Specification 2.0 available at www.USB.org). In one embodiment, the hub controller has an upstream connection to a host processor or to a downstream connection of a previous stacked hub controller via the docking connector 314. In one embodiment, the hub controller 302 can be a Philips ISP1521. In other embodiments, the hub controller 302 can include other suitable hardware and/or software and can depart from USB specifications.

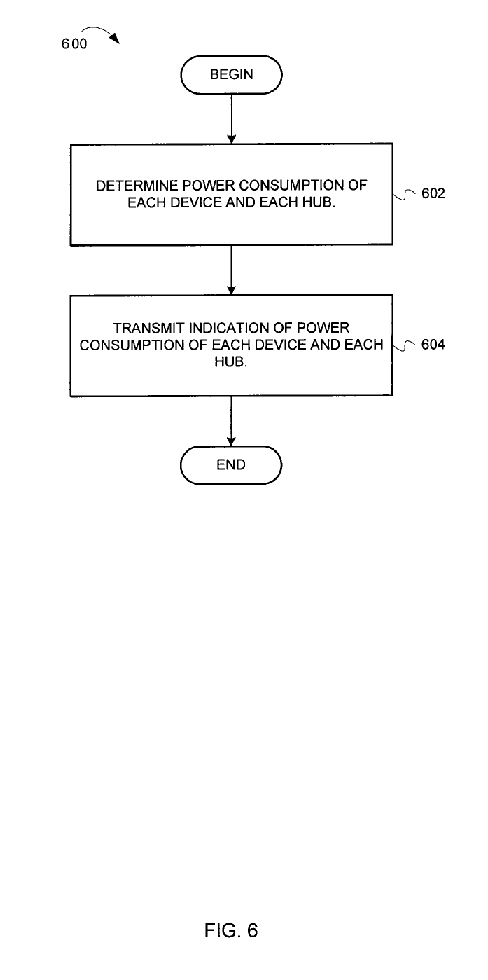

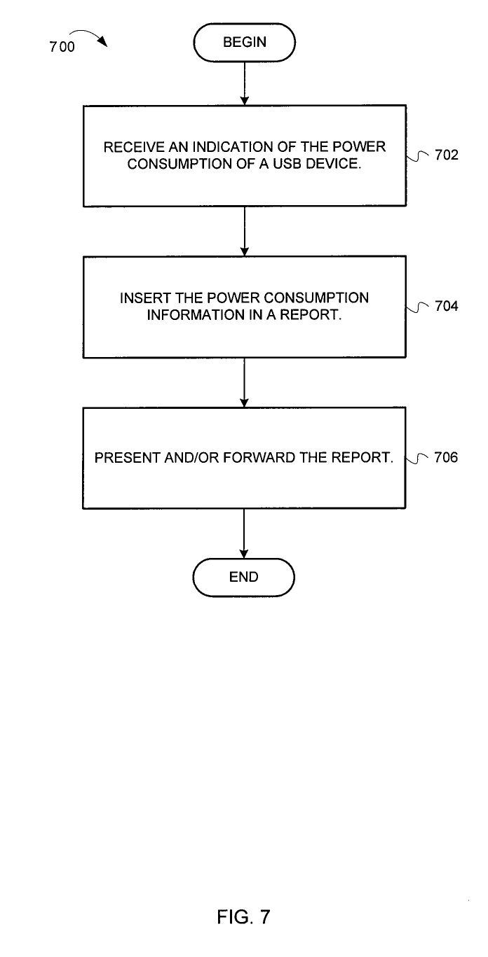

The power monitoring unit 304 can monitor voltages of USB devices connected to the sockets 308, in order to ensure that the USB devices are operating within their specified voltage ranges. Additionally, in one embodiment, the power monitoring unit 304 can monitor current drawn by the USB devices. In one embodiment, because the power monitoring unit 304 can monitor voltage to and current drawn by USB devices connected to the sockets 308, the power monitoring unit 304 can monitor power consumption of the USB devices. In one embodiment, after the power monitoring unit 304 determines voltage and/or power consumption associated with one or more USB devices, it transmits this information to the hub controller 302. The hub controller 302 can forward this information to a host processor in USB data format (see discussion of FIGS. 6 and 7 for more details).

In one embodiment (shown in FIG. 3), the power monitoring unit 304 is connected to the USB sockets 308 and the docking connector 314. In an alternative embodiment, the power monitoring unit 304 can be connected to the hub controller 302 as a USB device. For example, the power monitoring unit 304 could be connected through a USB socket 308 or it could be connected to pins of the hub controller 302.

The docking socket 306 is connected to the hub controller 302 and the docking connector 314. The docking socket 306 can conduct power and USB data to another USB hub 324, as shown in FIG. 3. In one embodiment, the docking socket 306 and docking connector 314 can each be made of a single connector. Alternatively, the docking socket 306 and docking connector 314 can include two connectors: one connector for providing power and another for providing USB data. The arrows between the components show how the components can mate together forming a stack.

Although FIGS. 1-3 illustrate the power unit 322 and USB hubs 324 in a vertical stack, in one embodiment, the components can be mated horizontally. In other embodiments, the components can be mated in any suitable formation. In one embodiment, the docking USB power unit 322 can include all the components of a USB hub 324. Such an embodiment could reduce the space occupied by the USB power units and hubs.

### Example Computer System

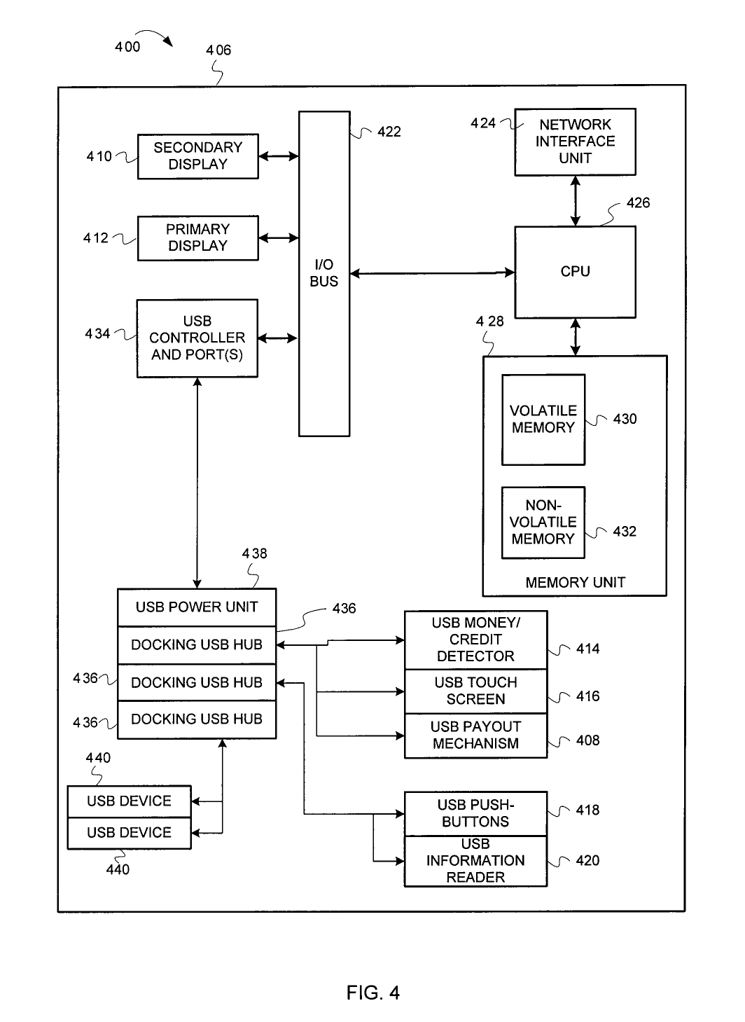

This section describes an example computer system used in conjunction with certain embodiments of the invention. FIG. 4 is a block diagram illustrating a gaming machine, used in conjunction with exemplary embodiments of the invention. As shown in FIG. 4, the gaming machine 400 includes a cabinet 406 that contains gaming machine components. Inside the cabinet 406, a CPU 426 is connected to a memory unit 428, which includes a volatile memory 430 (e.g., random access memory) and a nonvolatile memory 432 (e.g., read only memory, hard disk drive, etc.). The CPU 426 is also connected to an input/output (I/O) bus 422. The I/O bus 422 is connected to a secondary display 410, primary display 412, and USB controller and port 434. The I/O bus 422 facilitates communication between the system components and the CPU 426. According to some embodiments, the gaming machine 406 can include additional peripheral devices and/or more than one of the components shown in FIG. 4. For example, in one embodiment, the gaming machine 406 can include multiple network interface units 424 and multiple CPUs 426. Additionally, the components of the gaming machine 406 can be interconnected according to any suitable interconnection architecture (e.g., directly connected, hypercube, etc.).

In FIG. 4, the USB controller and port 434 is connected to a docking USB power unit 438, which is connected to a stack of docking USB hubs 436. One of the docking USB hubs 436 is connected to a set of USB devices 440, while another of the USB hubs 436 is connected to a USB money/credit detector 414, USB touch screen 416, and USB payout mechanism 408. Yet another of the docking USB hubs 436 is connected to USB pushbuttons 418 and USB information reader 420. In one embodiment, all the USB devices are connected to USB ports in the docking USB hubs 436. In FIG. 4, the USB power unit 438, docking USB hubs 436, and all the USB devices are contained within the cabinet 406. In other embodiments, any of these components can be placed outside the cabinet 406.

According to some embodiments, any component of the gaming machine 406 can include machine-readable media including instructions for conducting operations described herein. In one embodiment, the gaming machine 406 includes machine-readable media for conducting a basic wagering game, conducting a bonus game, storing non-monetary player information, and other operations. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.). According to embodiments of the invention, the gaming machine 406 can include other types of logic (e.g., digital logic) for executing the operations described herein. For example, the gaming machine 400 can include software for receiving, processing, and/or generating reports describing power consumption of one or more of the USB devices 440.

According to embodiments, the gaming machine 406 can present any casino style wagering game, such as video poker, video black jack, video slots, etc. In one embodiment, the wagering games can include a base game and a bonus game. When presenting the base game, the gaming machine 406 can present a plurality of symbols that indicate a randomly selected outcome, which is selected from a plurality of outcomes. For example, when presenting a video slots game, the gaming machine 406 can present a set of real symbols that indicates the game's outcome. Based on the outcome, the gaming machine 406 can provide monetary awards and non-monetary assets.

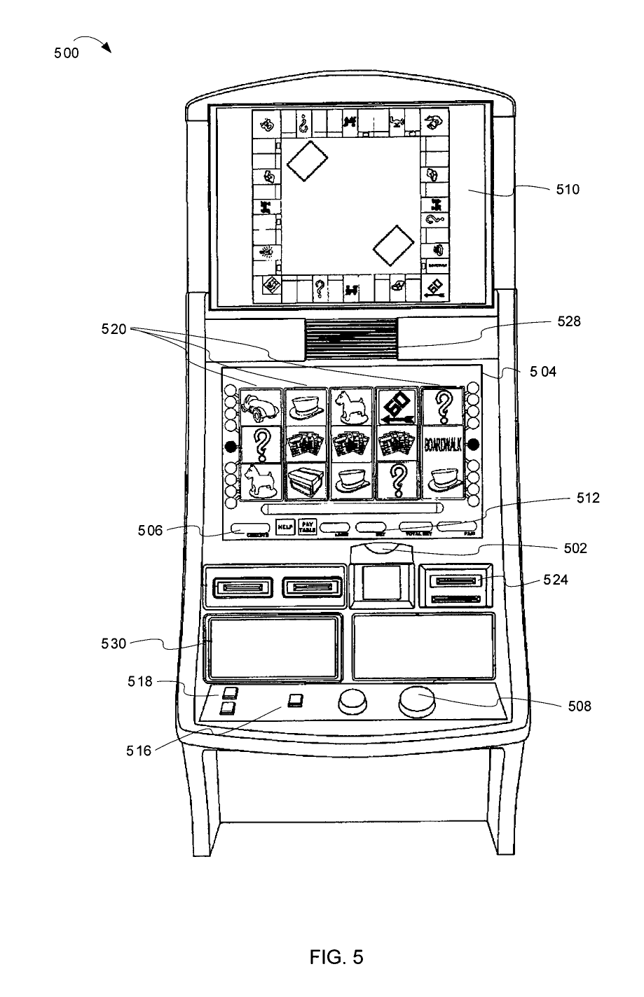

While FIG. 4 describes a computer system used with some embodiments of the invention, FIG. 5 describes a gaming machine in greater detail.

FIG. 5 is a perspective view of a gaming machine, according to example embodiments of the invention. As shown in FIG. 5, the gaming machine 500 can be a computerized slot machine having the controls, displays, and features of a conventional slot machine.

The gaming machine 500 can be operated while players are standing or seated. Additionally, the gaming machine 500 is preferably mounted on a stand (not shown). However, it should be appreciated that the gaming machine 500 can be constructed as a pub-style tabletop game (not shown), which a player can operate while sitting. Furthermore, the gaming machine 500 can be constructed with varying cabinet and display designs. The gaming machine 500 can incorporate any primary game such as slots, poker, or keno, and additional bonus round games. The symbols and indicia used on and in the gaming machine 500 can take mechanical, electrical, or video form.

As illustrated in FIG. 5, the gaming machine 500 includes a coin slot 502 and bill acceptor 524. Players can place coins in the coin slot 502 and paper money or ticket vouchers in the bill acceptor 524. Other devices can be used for accepting payment. For example, credit/debit card readers/validators can be used for accepting payment. Additionally, the gaming machine 500 can perform electronic funds transfers and financial transfers to procure monies from financial accounts. When a player inserts money in the gaming machine 500, a number of credits corresponding to the amount deposited are shown in a credit display 506. After depositing the appropriate amount of money, a player can begin playing the game by pushing play button 508. The play button 508 can be any play activator used for starting a wagering game or sequence of events in the gaming machine 500.

As shown in FIG. 5, the gaming machine 500 also includes a bet display 512 and a “bet” button 516. The player places a bet by pushing the bet button 516. In one embodiment, the player can increase the bet by one credit each time the player pushes the bet button 516. In another embodiment, the player can increase the bet by two, three, or more credits each time the player pushes the bet button 516. When the player pushes the bet one button 516, the number of credits shown in the credit display 506 decreases by one credit, while the number of credits shown in the bet display 512 increases by one credit.

A player may “cash out” by pressing a cash out button 518. When a player cashes out, the gaming machine 500 dispenses a voucher or currency corresponding to the number of remaining credits. The gaming machine 500 may employ other payout mechanisms such as credit slips (which are redeemable by a cashier) or electronically recordable cards (which track player credits), or electronic funds transfer.

The gaming machine also includes a primary display unit 504 and a secondary display unit 510 (also known as a “top box”). The gaming machine may also include an auxiliary video display. In one embodiment, the primary display unit 504 displays a plurality of video reels 520. According to embodiments of the invention, the display units 504 and 510 can include any visual representation or exhibition, including moving physical objects (e.g., mechanical reels and wheels), dynamic lighting, and video images. In one embodiment, each reel 520 includes a plurality of symbols such as bells, hearts, fruits, numbers, letters, bars or other images, which correspond to a theme associated with the gaming machine 500. Furthermore, as shown in FIG. 5, the gaming machine 500 includes an audio presentation unit 528. The audio presentation unit 528 can include audio speakers or other suitable sound projection devices. In one embodiment, one or more gaming machines 500 can be part of a system that includes a docking USB power unit and one or more docking USB hubs.

Although the discussion of FIGS. 4 and 5 describes using the docking power unit and docking USB hubs in a wagering game environment, other embodiments call for using these components in other computing environments. For example, docking power units and USB hubs can be used with desktop computers, laptop computers, tablet computers, cash registers, or any other computer system that utilizes USB devices.

### System Operations

This section describes operations performed by embodiments of the invention. In certain embodiments, the operations are performed by instructions residing on machine-readable media (e.g., software), while in other embodiments, the operations are performed by hardware or other logic (e.g., digital logic).

This section discusses FIGS. 6 and 7. In particular, FIGS. 6 and 7 describe operations for determining and reporting USB power consumption. FIGS. 6 and 7 will be described with reference to the systems shown in FIGS. 3 and 4. This description will proceed with a discussion of FIG. 6.

FIG. 6 is a flow diagram illustrating operations for determining power consumption of USB devices, according to example embodiments of the invention. The flow diagram 600 commences at block 602.

At block 602, a determination is made about power consumption of each USB device and each USB hub. For example, the power monitoring unit 304 determines a USB device's power consumption by monitoring the USB sockets 308. The flow continues at block 604.

At block 604, an indication of the USB device's power consumption is transmitted. For example, the power monitoring unit 304 transmits to an indication of power consumed by a USB device to the hub controller 302. The hub controller 302 can forward the power consumption information to a host processor (e.g., CPU 426). In one embodiment, the hub controller 302 forwards the power consumption information in USB data format. In one embodiment, the hub controller 302 transmits the power consumption information through the docking socket 328 into the power unit 322 and onto a host processor. From block 604, the flow ends.

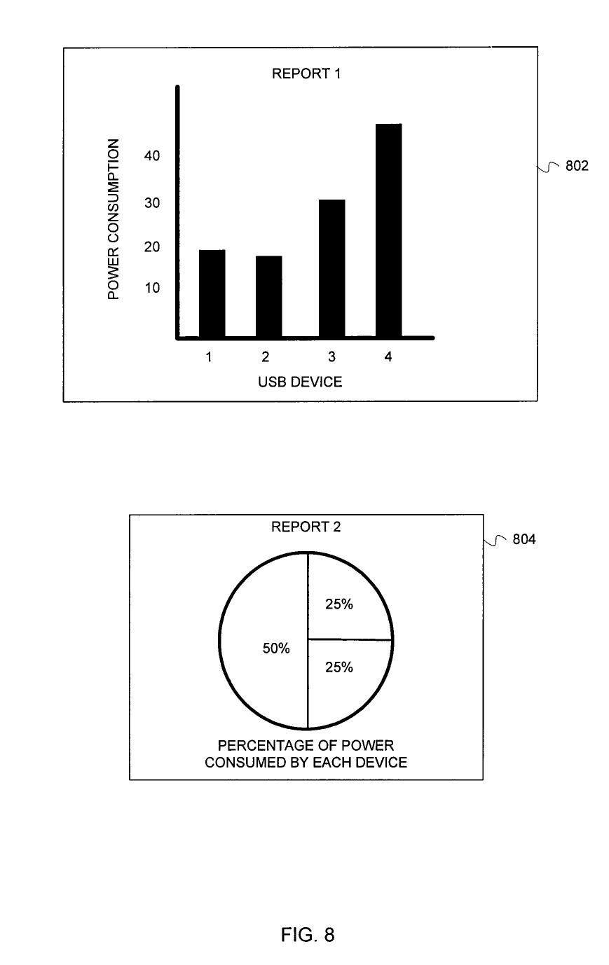

While FIG. 6 describes operations for determining USB device power consumption, FIGS. 7 and 8 describe operations for reporting the USB power consumption.

FIG. 7 is a flow diagram illustrating operations for creating a power consumption report, according to example embodiments of the invention. The flow 700 begins at block 702.

At block 702, an indication of the power usage of a USB device is received. For example, a host processor (e.g., CPU 426) receives from a hub controller 302 an indication of the power usage of a USB device. In one embodiment, the indication is in USB data format. The flow continues at block 704.

At block 704, the USB device power consumption information is inserted into a report. For example, a host processor and/or software running thereon inserts the USB device power consumption information into a human-readable report describing power consumption of a USB device. Example reports are described below, in the discussion of FIG. 8. The flow continues at block 706.

At block 706, the report is presented and/or forwarded. For example, a host processor presents the power consumption report on a display device (e.g., the primary display 412). In an embodiment in which the host processor is part of a wagering game machine, the host processor can forward the report to a system maintenance computer. In one embodiment, the host processor can forward the report via e-mail to a system administrator. Other embodiments call for other suitable methods of data transmission. From block 706, the flow ends.

### Power Consumption Reports

This section describes some example human-readable USB power consumption reports. Although only two reports are discussed below, embodiments of the invention call for any suitable human-readable gaming machine report format.

FIG. 8 shows human-readable gaming machine reports, according to example embodiments of the invention. In FIG. 8, reports 1 and 2 present USB device power consumption information as human-readable reports. In one embodiment, a host processor can represent raw USB power consumption information in any suitable graphical format. For example, the host processor can create reports which include 2-D and 3-D line charts, bar charts, and pie graphs. In one embodiment, the reports can include non-chart graphics (e.g., casino floor diagrams) and/or text.

Report 1 (802) includes a bar graph representing power consumption of four USB devices. Report 2 (804) includes a pie graph representing a percentage of power consumption for three USB devices.

The human-readable power consumption reports described above enable wagering game operators to quickly understand performance of gaming machines on their casino floor. Furthermore, because embodiments of the system described above automatically create and deliver human-readable reports, wagering game operators can quickly learn of abnormal USB device power consumption.

### General Comments

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” means that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description.

Herein, block diagrams illustrate example embodiments of the invention. Also herein, flow diagrams illustrate operations of the example embodiments of the invention. The operations of the flow diagrams are described with reference to the example embodiments shown in the block diagrams. However, it should be understood that the various flow diagram operations could be performed by embodiments other than those referenced in the block diagrams. Furthermore, the block diagrams can perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

1. A gaming device comprising:
a plurality of docking USB hubs mated together forming a stack, the docking USB hubs to receive data from a plurality of USB devices;
a docking USB power unit mated to one of the docking USB hubs, the USB power unit to provide power to the docking USB hubs and to receive USB data from the docking USB hubs; and
a host processor to receive the data from the docking USB power unit and to conduct wagering games using the data.

2. The gaming device of claim 1, wherein each of the docking USB hubs includes a power monitoring unit to monitor power consumed by the USB devices.

3. The gaming device of claim 1, wherein each docking USB hub to transmit to the host processor an indication of the power consumed by the USB devices and the host processor to create a report describing the power consumed by the USB devices.

4. The gaming device of claim 1, the host processor to email the report to a gaming machine administrator.

5. A docking Universal Serial Bus (USB) power unit comprising:
a USB socket to receive USB data;
a power socket to receive power of a first type;
a switching power unit to convert the power of the first type into power of a second type; and
a docking connector to join the docking USB power unit to a USB hub, the USB hub to dock with the docking USB power unit, the docking connector to conduct the USB data and some of the power of the second type to the USB hub.

6. The apparatus of claim 5, wherein the docking USB power unit does not include a means for processing the USB data.

7. The apparatus of claim 5, the USB socket to couple to a type B USB connector that is coupled to a host computer.

8. The apparatus of claim 5, wherein the power of the first type is alternating current power, and wherein the power of the second type is direct current power.

9. An apparatus comprising:
a first connector to affix the apparatus to a first Universal Serial Bus (USB) hub and to receive power and USB data from the first USB hub;
a hub controller to receive the USB data and some of the power and to transmit the USB data to a second USB hub; and
a second connector to affix the apparatus to the second USB hub and to conduct the USB data and some of the power to the second USB hub.

10. The apparatus of claim 9, wherein the apparatus, first USB hub, and second USB hub are affixed in coaxial adjacency.

11. The apparatus of claim 9 further comprising:
a plurality of USB connectors coupled to the hub controller and to the first connector; and
a power monitoring unit to monitor power received by the USB connectors.

12. The apparatus of claim 9, the power being at +5V, +12V, and +24V, and the apparatus further including a plurality of USB connectors coupled to the hub controller and to the first connector, one of the USB connectors to provide the power at +5V, +12V, and +24V.

13. An apparatus comprising:
a Universal Serial Bus (USB) hub controller to receive USB data and power, the USB data received from a host computer, and the USB hub controller to process the USB data;
a plurality of USB sockets communicatively coupled to the USB hub controller, the plurality of USB sockets to conduct the USB data and some of the power to a plurality of USB devices; and
a power monitoring unit to determine how much of the power is consumed by ones of the plurality of USB devices.

14. The apparatus of claim 13, the power monitoring unit to transmit to the USB hub controller an indication of the power consumed by ones of the USB devices, the USB hub controller to forward the indication to a host processor.

15. The apparatus of claim 14, the indication in USB data format.

16. The apparatus of claim 13, wherein the apparatus further comprises:
a docking connector through with the power is received, the docking connector coupled to the USB controller, the docking connector to dock the apparatus with a USB hub.

17. The apparatus of claim 13, wherein the USB sockets can receive Type A and Type B USB connectors.

18. A method comprising:
receiving from a USB hub an indication of power consumption of a USB device, wherein the USB hub determines the power consumption by measuring current and voltage to the USB device; and
creating a report describing the power consumption, the report based on the indication.

19. The method of claim 18, further comprising:
emailing the report to a system administrator.

20. The method of claim 19, wherein the USB hub is connected to a wagering game machine.
